(19) United States
(12) Patent Application Publication
(10) Pub. No.: US 2004/0016162 A1
(43) Pub. Date: Jan. 29, 2004

(54) Vehicular permit display

(76) Inventor: Bibian J. Rendon, Murray, UT (US)

Correspondence Address: GRANT R CLAYTON, CLAYTON HOWARTH & CANNON, PC, P O BOX 1909, SANDY, UT, 84091-1909, US

(21) Appl. No.: 10/624,205

(22) Filed: Jul. 21, 2003

Related U.S. Application Data
(60) Provisional application No. 60/397,473, filed on Jul. 19, 2002.

(51) Int. Cl. G09F 3/18

(52) U.S. Cl. 40/654.01

(57) ABSTRACT

A device for displaying a parking permit and attaching the permit to a rear view mirror of a vehicle. The device may include a hook and pocket formed of a single piece of substantially rigid and transparent plastic material. The hook may be formed as an open loop on a first end of the device. The hook may extend to the pocket to form a first planar wall. The second end of the device may be folded to form a second planar wall that is substantially parallel to the first planar wall. The parking permit may be positioned between the first planar wall and the second planar wall. The rigidity of the device prevents the device from falling off of the rear view mirror so that the permit can be seen through the vehicle windshield.

### CROSS-REFERENCE TO RELATED APPLICATIONS

The application claims the benefit of U.S. provisional application no. 60/397,473 filed on Jul. 19, 2002.

### STATEMENT REGARDING FEDERALLY SPONSORED RESEARCH OR DEVELOPMENT

Not Applicable.

### BACKGROUND OF THE INVENTION

1. The Field of the Invention

The present invention relates generally to placard display devices, and more particularly, but not necessarily entirely, to a device for displaying permits on a rear view mirror of a vehicle.

2. Description of Related Art

It is common practice to require permits to be displayed in vehicles in order to establish the right to park in particular areas. For example, parking spaces are commonly established only for drivers who have disabilities, often referred to as “handicap parking space.” These parking spaces are often situated in locations selected to enhance convenience for disabled drivers and passengers. A handicap permit issued by an appropriate government agency is usually required to park in the designated handicap parking spaces and the handicap permit must be displayed in a manner that allows it to be viewed from outside the vehicle or the owner of the vehicle risks receiving a citation imposing a severe monetary fine. The handicap permits are commonly provided in a paper thin, pliable plastic cover having a structure intended to hang on the rear view mirror of the vehicle positioned on the interior of the vehicle windshield. The plastic covers are easily folded by hand. The permit may be removed from the rear view mirror prior to driving so that the driver's field of view is not obstructed by the permit.

The pliable permit covers which have been available have several drawbacks. For example, interiors of vehicles are often subjected to extreme heat conditions when the vehicle is parked outside in the sunshine. The intense heat causes the flexible permit covers to become even more pliable which may cause the hook to release from the rear view mirror under the weight of the cover and the permit. Similarly, repeated flexing of the hook to install and remove the permit may cause the hook to weaken which will cause the flexible permit cover to more easily fall from its position hanging from the rear view mirror. When the permit falls from the rear view mirror, it is often out of sight of an officer enforcing parking regulations. This may prove to be a costly problem since steep fines are commonly established for parking in handicap parking stalls without. a visible permit. Moreover, in some jurisdictions, vehicles can be towed away if a proper permit is not visible.

Another problem associated with the flexible permit covers is that the print on the permits often sticks to the flexible cover. Thus, when the permit is moved within the cover, the print may remain adhered to the cover. This may make viewing the permit more difficult and may cause damage to the permit.

It is also known to form placards of a single piece of material having a hook formed integrally with the placard. For example, there is available in the art a placard having a structure with a hook shape. There is also available in the art a placard holding device including a support for attaching the placard to a sun visor provided in a vehicle with the structure being swing between a position where the placard is hidden from view by the sun visor and a position where the placard can be seen from outside the vehicle. Disadvantageously, the cost of producing such a placard holding device with a structure allowing swinging motion is prohibitive to many users of handicapped permits and the additional structure in such a placard holding device increases the likelihood that the structure will fail to operate properly. The increased costs of such a structure is significant to the users of handicap parking spaces. Moreover, there are also structures available provided with a hook to allow particular documents (such as a recipe card or a photograph) to be hung from a support (such as kitchen cabinet handle, door knob, or nail) which do not contemplate and meet the particular challenges which must be met when a permit is to be hung inside a vehicle.

Thus, it would be an advance in the art to provide a device for supporting and displaying a permit that is simple in design and manufacture. It would also be an advance in the art to provide such a display device that is strong enough to support a permit even in extreme heat conditions encountered in a vehicle parked in the sunshine. It would be a further advance to provide a permit support device that can be used to interchange permits without causing damage to the permits or the device.

The available art is thus characterized by several disadvantages that are addressed by the present invention. The present invention minimizes, and in some aspects eliminates, the above-mentioned failures, and other problems, by utilizing the methods and structural features described herein.

The features and advantages of the invention will be set forth in the description which follows, and in part will be apparent from the description, or may be learned by the practice of the invention without undue experimentation. The features and advantages of the invention may be realized and obtained by means of the instruments and combinations particularly pointed out in the appended claims.

### BRIEF DESCRIPTION OF THE DRAWINGS

The features and advantages of the invention will become apparent from a consideration of the subsequent detailed description presented in connection with the accompanying drawings in which:

FIG. 1 is a front view of a vehicular permit display device in accordance with the principles of the present invention;

FIG. 2 is a side view of a vehicular permit display device;

FIG. 3 is a top view of a vehicular permit display device;

FIG. 4 is a bottom view of a vehicular permit display device; and

FIG. 5 is a perspective view of a vehicular permit display device attached to a rear view mirror as viewed from an exterior of a vehicle.

### DETAILED DESCRIPTION OF THE ILLUSTRATIVE EMBODIMENT

For the purposes of promoting an understanding of the principles in accordance with the invention, reference will now be made to the embodiment illustrated in the drawings and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention claimed.

It must be noted that, as used in this specification and the appended claims, the singular forms “a,” “an,” and “the” include plural referents unless the context clearly dictates otherwise.

In describing and claiming the present invention, the following terminology will be used in accordance with the definitions set out below.

As used herein, “comprising,” “including,” “containing,” “characterized by,” and grammatical equivalents thereof are inclusive or open-ended terms that do not exclude additional, unrecited elements or method steps.

As used herein, “consisting of” and grammatical equivalents thereof exclude any element, step, or ingredient not specified in the claim.

As used herein, “consisting essentially of” and grammatical equivalents thereof limit the scope of a claim to the specified materials or steps and those that do not materially affect the basic and novel characteristic or characteristics of the claimed invention.

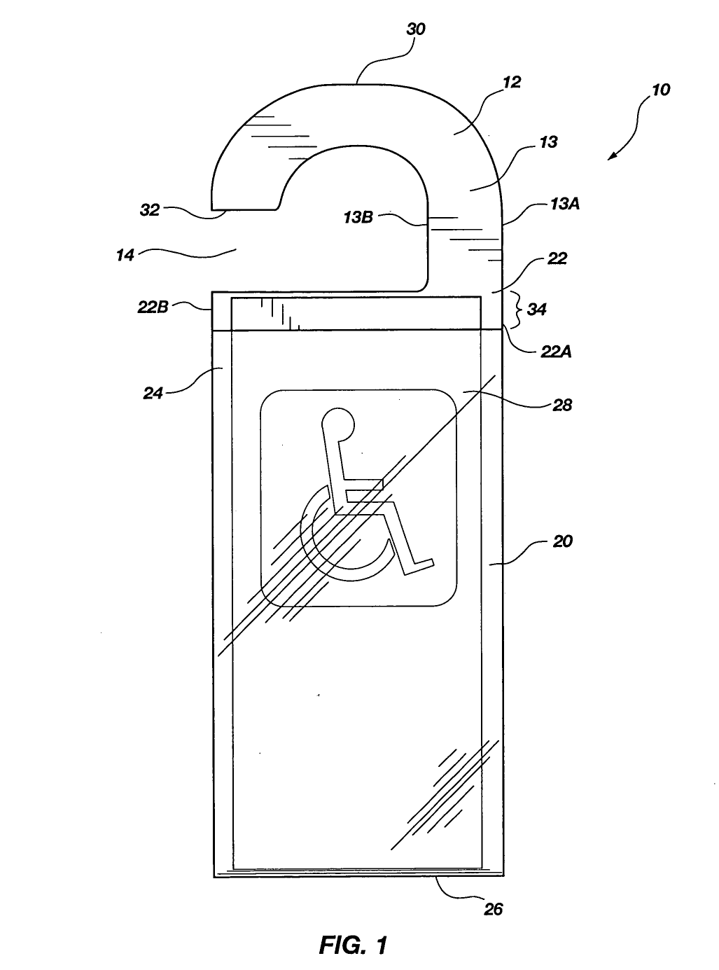

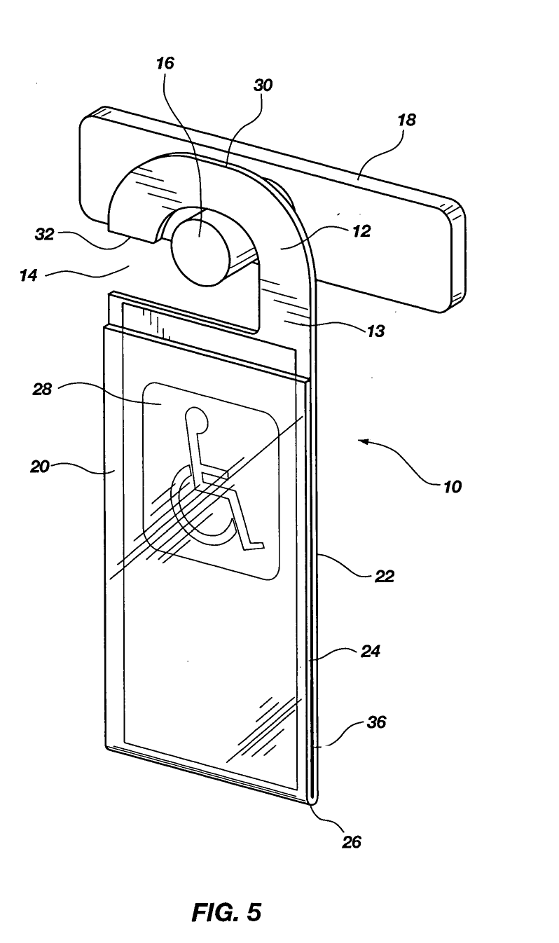

Referring now to FIG. 1, a front view of a device for supporting a display on a rear view mirror of a vehicle is shown indicated generally at 10. The device 10 may include a hook 12 having an opening 14 for receiving a post 16 on a rear view mirror 18 as best shown in FIG. 5. It will be appreciated that the hook 12 may have various different configurations within the scope of the present invention to allow the post 16 to be inserted into the opening 14 such that the device 10 may be supported by the post 16. It will be appreciated that while the illustrative embodiment of the present invention is best described in connection with a rear view mirror attached to a vehicle windshield, the present invention has much broader application.

Typically, the hook 12 is comprised of a shank 13 having an outside edge 13A, inside edge 13B. The width of the shank 13 may be about 1 inch between the outside edge 13A and the inside edge 13B. The width of the free end 32 being about the same as that of the width of the shank 13, about 1 inch. The outside edge 13A of the shank 13 beginning from a first edge 22A of a first planar wall 22. The first edge 22A being in substantially a vertical direction when the device 10 is hung from a rear view mirror. The shank 13 may be of any length but is typically at least one inch in length.

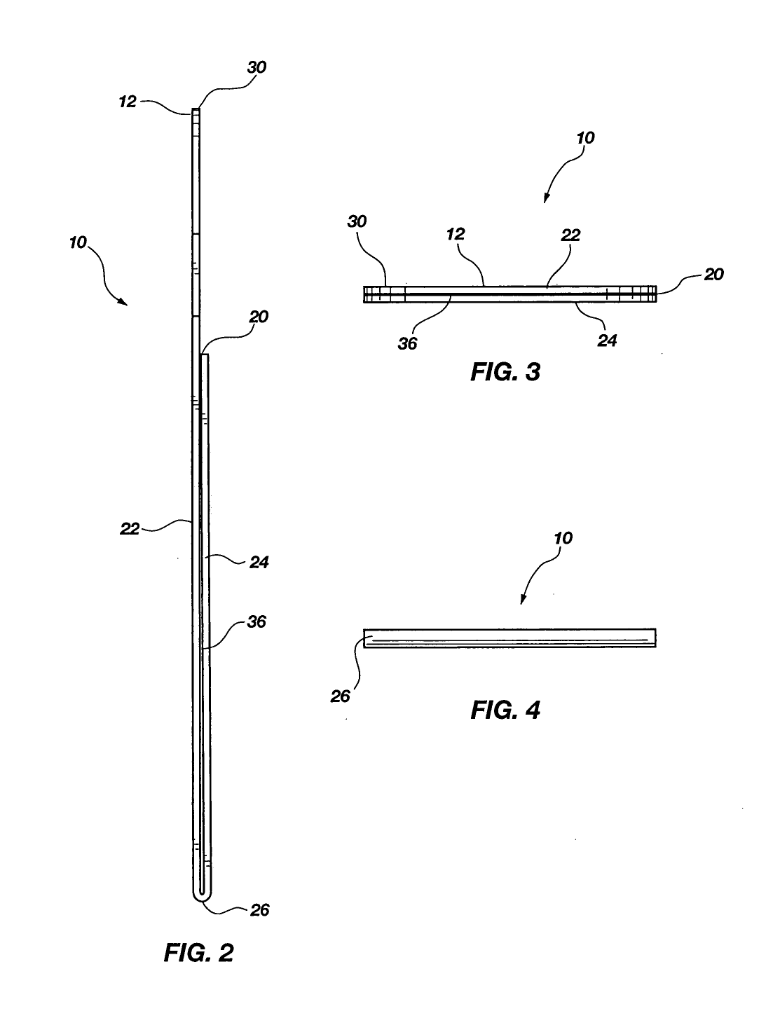

As shown most clearly in FIG. 2, the device 10 illustratively includes a pocket 20 defined by the first planar wall 22, a second planar wall 24 and a fold 26 connecting the first planar wall 22 to the second planar wall 24. The first planar 22 wall may be co-planar with the hook 12 and the second planar 24 wall may be oriented substantially parallel to the first planar wall 22. A display 28, such as a parking permit, may be placed in the pocket 20 between the first planar wall 22 and the second planar wall 24. It will be appreciated that the display 28 may include various different types of placards, such as permits, advertisements or other written information or images, all within the scope of the present invention.

The device 10 may be constructed of a transparent material such as a clear thermoplastic material. Thus, the display 28 may be viewed from the outside of the pocket 20 through the first planar wall 22 and the second planar wall 24. Moreover, the display 28 may have images on both the front side and the back side such that the images can be viewed on both sides of the pocket 20.

The device 10 may be constructed of a substantially rigid thermoplastic material having adequate stiffness to support the weight of the device 10 and the display 28 without appreciable deflection, even under the extreme heat conditions encountered in a vehicle parked in the sunshine. The term “thermoplastic” as used herein refers to materials that have the property of softening or fusing when heated to a critical temperature and of hardening and becoming rigid again when cooled, even to the elevated temperatures found in vehicles when parked under the sun during the Summer months. In this way, the embodiments of the present invention provide significant advantages over previously available devices which are constructed of a thin pliable material that can be folded without breaking under normal ambient temperatures.

In one illustrative embodiment of the present invention, the device 10 may be formed of a single piece of clear plastic having the dimensions of about 20 inches in length, about 4.5 inches wide, and about 0.125 inches thick. It will be appreciated that the dimensions of the device 10 provided herein are merely examples of the dimensions that are possible, and that other dimensions are also considered to be included within the scope of the present invention. The pocket 20 may be formed by heat folding the piece of plastic to form the second planar wall 24 to have a length of about 8 inches. A spreadable gap 36 may be formed between the first planar wall 22 and the second planar wall 24 for receiving the display 28. The spreadable gap 36 may. illustratively have a dimension of about 0.0625 inch near the fold 26 and narrow in dimension along the length of the second planar wall 24 such that the second planar wall 24 contacts the first planar wall 22 at a point away from the fold 26, and the second planar wall 24 is biased toward the first planar wall 22 so that the display 28 is held in place but can be readily removed when desired.

The hook 12 may be formed in a first end 30 of the device such that the opening 14 may be dimensioned about 1.25 inch from the first planar wall 22 to the free end 32 of the hook 12. The opening 14 may also be in the range from about .5 to about 1.5 inches wide, or any other width to accommodate a support post for a rear view mirror. The length of the second planar wall 24 may be less than the length of the first planar wall 22 to form a space 34 between the hook 12 and the second planar wall 24 such that the display 28 may be supported to extend beyond the second planar wall 24. This advantageous structure enables the display 28 to be accessed more easily for removal or replacement but also holds the display 28 in the proper place to avoid loss or damage. The dimension 34 may illustratively be in the range from about 0.5 inch to about 1 inch.

The fold 26 may form a hinge such that a user may spread the first planar wall 22 apart from the second planar wall 24 at an end opposite the fold 26. The display 28 may then be inserted in the pocket 20. The fold 26 may provide resilient properties such that the first planar wall 22 and the second planar wall 24 provide a compressive force to hold the display 28 in the pocket 20. The hook 12 may be placed on a post 16 of a rear view mirror 18 by inserting the post 16 through the opening 14. The rigidity of the hook 12 allows the device 10 to remain in position even under extreme temperature conditions which may be present in a parked vehicle. The device 10 may have a compact configuration that is easy to keep secure in an auto pocket, console, or compartment when the device 10 is not in use.

It will be appreciated that the present invention may be used in other applications for displaying placards in addition to displaying vehicle permits, all of which are to be considered within the scope of the present invention.

In accordance with the features and combinations described above, a useful illustrative method of forming a display support includes the steps of:

a) obtaining a single piece of transparent material having sufficient rigidity to support the weight of said display support and the weight of a display without substantial deflection;

b) forming a hook in a first end of said transparent material;

c) forming a fold in said transparent material to define a pocket having a first planar wall co-planar with said hook, and a second planar wall substantially parallel with said first planar wall; and

d) inserting said display in said pocket.

Those having ordinary skill in the relevant art will appreciate the advantages provided by the features of the present invention. For example, it is a feature of the present invention to provide a device for supporting a display that is simple to manufacture and which is reliable. It is another feature of the present invention to provide such display device that can support a display in extreme heat conditions encountered in a vehicle parked under the sun in a hot season. It is a further feature of the present invention, in accordance with one aspect thereof, to provide a display support device that can be used to interchange the display without causing damage to the display or the device.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A device for supporting a display on a rear view mirror of a vehicle, said rear view mirror having a post for connecting said mirror to said vehicle, said device comprising:
a hook configured to receive said post for hanging said device;
a pocket connected to said hook, said pocket configured for receiving said display; and
wherein said hook is formed of a rigid material such that said display is supported in said pocket without deforming said hook.

2. The device of claim 1, wherein said device is formed of a one piece unitary construction.

3. The device of claim 2, wherein said device is constructed of a thermoplastic material.

4. The device of claim 1, wherein said pocket comprises a first planar wall and a second planar wall.

5. The device of claim 4, wherein said first planar wall and said second planar wall are connected together through a single fold.

6. The device of claim 5, wherein said first planar wall is formed co-planar with said hook, and said second planar wall is substantially parallel with said first planar wall.

7. The device of claim 6, wherein a length of said second planar wall is less than a length of said first planar wall to provide a space between an end of said second planar wall and said hook to facilitate accessing said display.

8. The device of claim 5, wherein said first planar wall is connected to said second planar wall only along said single fold such that said first planar wall is separable from said second planar wall along a length of said second planar wall away from said fold and the first planar wall and the second planar wall are biased toward each other to hold the display in position there between.

9. The device of claim 1, wherein said device is formed of a transparent material such that said display can be viewed through said pocket.

10. The device of claim 1, wherein said hook is formed as an open loop.

11. A device for supporting a display, said device comprising:
a hook configured to receive a support for hanging said device;
a pocket integrally connected to said hook, said pocket configured for receiving said display, said pocket comprising a unitary member forming a first planar wall and a second planar wall, said first planar wall and said second planar wall being connected only at a fold along a bottom portion of said device; and
wherein said pocket is formed of a transparent material such that said display may be viewed through said pocket.

12. The device of claim 11, wherein said device is constructed of a substantially rigid plastic material.

13. The device of claim 11, wherein said first planar wall is formed co-planar with said hook, and said second planar wall is substantially parallel with said first planar wall.

14. The device of claim 11, wherein a length of said second planar wall is less than a length of said first planar wall to provide a space between an end of said second planar wall and said hook.

15. The device of claim 11, wherein said hook is formed as an open loop.

16. The device of claim 11, wherein said fold provides a hinge such that said first planar wall can be separated from said second planar wall for inserting said display between said first planar wall and said second planar wall and the second planar wall are biased toward each other to hold the display in position there between.

17. A method for forming a display support, said method comprising the steps of:
a) obtaining a single piece of transparent material having sufficient rigidity to support the weight of said display support and the weight of a display without substantial deflection;
b) forming a hook in a first end of said transparent material; and
c) forming a fold in said transparent material to define a pocket having a first planar wall co-planar with said hook, and a second planar wall substantially parallel with said first planar wall.

18. The method of claim 17, further comprising inserting said display in said pocket.

19. The method of claim 18, further comprising holding the display in said pocket with a compressive force created by said first planar wall and said second planar wall imposed by said fold.

20. A device for supporting a display on a rear view mirror of a vehicle, said rear view mirror having a post for connecting said mirror to said vehicle, said device comprising:
a hook configured to receive said post for hanging said device, said hook formed as an open loop; and
a pocket for receiving said display, said pocket integrally connected to said hook and comprising a unitary member forming a first planar wall and a second planar wall, said first planar wall and said second planar wall being connected only at a U-shaped fold along a bottom portion of said device;
wherein said hook is formed of a substantially rigid material such that said display is supported in said pocket without deforming said hook;
wherein said first planar wall is formed co-planar with said hook, and said second planar wall is substantially parallel with said first planar wall;
wherein a length of said second planar wall is less than a length of said first planar wall to provide a space between an end of said second planar wall and said hook; and
wherein said device is formed of a transparent material such that said display can be viewed through said first planar wall and said second planar wall.

21. The device of claim 20 wherein the hook comprises a shank having a first and second edge, the first edge of the shank being contiguous with a first edge of the first planar wall, the first edge of the planar wall residing in a near vertical position when the device is hung from a rear view mirror, and the second edge of the shank being contiguous with a top edge of the first planar wall, the top edge of the first planar wall residing in a near horizontal position when the device is hung from a rear view mirror.

22. The device of claim 21 wherein the shank is about one inch wide.

23. The device of claim 22 wherein the hook further comprises a free end, the free end being about one inch wide and forming an space between itself and the top of the first planar wall whereby the post of the rear view mirror can be inserted.

24. The device of claim 23 wherein the space is in the range from about one inch to about one and one half inches wide.

25. The device of claim 24 wherein the second planar wall has a height of about eight inches and the first planar wall has a height of about eight and one half inches.

26. The device of claim 25 wherein the free end of the hook is parallel to the top edge of the first planar wall.

27. The device of claim 26 wherein the transparent material is about one eighth of an inch thick.

28. The device of claim 27 wherein the shank is at least one inch long.
